(19) United States
(12) Patent Application Publication
(10) Pub. No.: US 2004/0037169 A1
(43) Pub. Date: Feb. 26, 2004

(54) Chess clock

(76) Inventors: Gilles Fondin, Nantes (FR); Cyrille Guillot, Hong Kong (CN)

Correspondence Address: YOUNG & THOMPSON, 745 SOUTH 23RD STREET 2ND FLOOR, ARLINGTON, VA, 22202

(21) Appl. No.: 10/297,721

(22) PCT Filed: Apr. 8, 2002
(86) PCT No.: PCT/FR02/01215

(30) Foreign Application Priority Data
Apr. 9, 2001 (FR) 01/04776

(51) Int. Cl. G04F 3/00

(52) U.S. Cl. 368/96

(57) ABSTRACT

The invention concerns a chess clock comprising a first clockwork mechanism (1) driven by its own quartz module (10), and a second mechanism (1′) likewise driven by its own quartz module (10′), powered by a common power source (14) on the terminals whereof they are mounted in parallel. The driving means of said clockwork mechanisms (1, 1′) consist of two switches (18, 18′) placed each on one of the electric circuits (15, 15′) powering said mechanisms (1, 1′). The two switches (18, 18′) comprise each a contact switch system (19, 19′) for opening or closing the corresponding electrical circuit (15, 15′), and an operating member (20, 20′). Said operating members (20 and 20′) are arranged each at the end of an articulated arm (21), forming a balance.

This invention concerns a clock for chess games.

One already knows, notably by the documents U.S. Pat. No. 4,464,060, FR-A-2 685 502, WO-A-97 07484 or still U.S. Pat. No. 5,420,830, clocks for chess games composed of a box wherein are integrated two pointer clockworks which are connected together so that only one of both can work at a time.

Each of the corresponding clockworks is associated with a control device, and both these control devices are connected together so that deactivating a first device causes, on the one hand the associated clockwork to stop, and on the other hand the other control device to be actuated, whereas the associated clockwork is triggered.

Thus, during a game of chess, when one of the players has played his move, he actuates the control device at his disposal to stop his own clockwork, and this action triggers the clockwork of his opponent to measure the time of reflection or time of play of the latter.

In particular, the document U.S. Pat. No. 4,464,060 describes such a clock for chess games, comprising two clockworks controlled by a quartz system and whereof the operation is controlled by means of a switch-actuating toggle lever.

Both clockworks are here controlled by the same quartz; and two quartz systems are provided, selected one or the other by a switching device, according to the requested speed and direction of rotation of the pointers of each dial.

The chess clock models known so far have relatively complex structures and their production costs are consequently rather high.

The purpose of this invention is to remedy these shortcomings while suggesting a clock for chess games with simplified structure.

In the clock for chess games according to this invention, both pointer clockworks are controlled by their own quartz module; they contain each an electric power supply circuit, and the control means of both these quartz clockworks are composed of two switches each situated on one of said electric circuits.

According to a preferred embodiment, both quartz clockworks of the clock are supplied by the same source of energy on the terminals whereof they are mounted in parallel.

According to a preferred embodiment, the clock comprises quartz clockworks, each integrated in its own box fitted with a positive terminal and with a negative terminal for their power supply by the source of energy. A system of electric wires connects, on the one hand, the positive terminal of the source of energy to the positive terminals of said boxes, and on the other hand, the negative terminal of said source of energy to the negative terminals of said boxes, to form the power supply circuits.

Still according to a preferred embodiment, both switching devices comprise each a contact system to open or close the corresponding electric circuit, as well as an operating member of said contact system, said operating members of each switch being arranged at each end of a hinged arm forming a pendulum.

According to a first possible embodiment, both system switches are fitted with means to lock, in a removable fashion, their active closing position of the corresponding electric circuit. According to another possible embodiment, they are fitted with means to lock, in a removable fashion, their inactive closing position of the circuit.

According to still a preferred embodiment, the hinged arm forming a pendulum of the clock is made of a conductive material, and this arm, connected to the power source by an electric wire, touches, according to its position, one of the contactors of both switches, to close the corresponding electric circuit.

Still according to the invention, both boxes forming both quartz clockworks are integrated in a main box which is fitted with a housing for the reception of one or several battery (batteries) intended for supplying said clockworks; this main box also comprises two transparent screens arranged opposite both dials of said clockworks, and it integrates two switches each fitted with an operating member in the form of a push-button, which push-buttons are placed each above the associated clockwork and emerge in the upper face of said main box.

This clock for chess games comprises still a main on/off switch enabling to break up the power supply of both clockworks.

According to still another particularity, each clockwork comprises a dial associated with an indicator of operation in the form of decorative or informative plate mounted on the axis of the seconds' hand, in replacement thereof.

The clock for chess games according to this invention is made on the basis of existing quartz-type clockworks, which are connected together by simplified control means, and it may consequently be obtained at relatively interesting production costs.

But the invention will be still illustrated, without being limited thereto, by the following description associated with the appended drawings wherein:

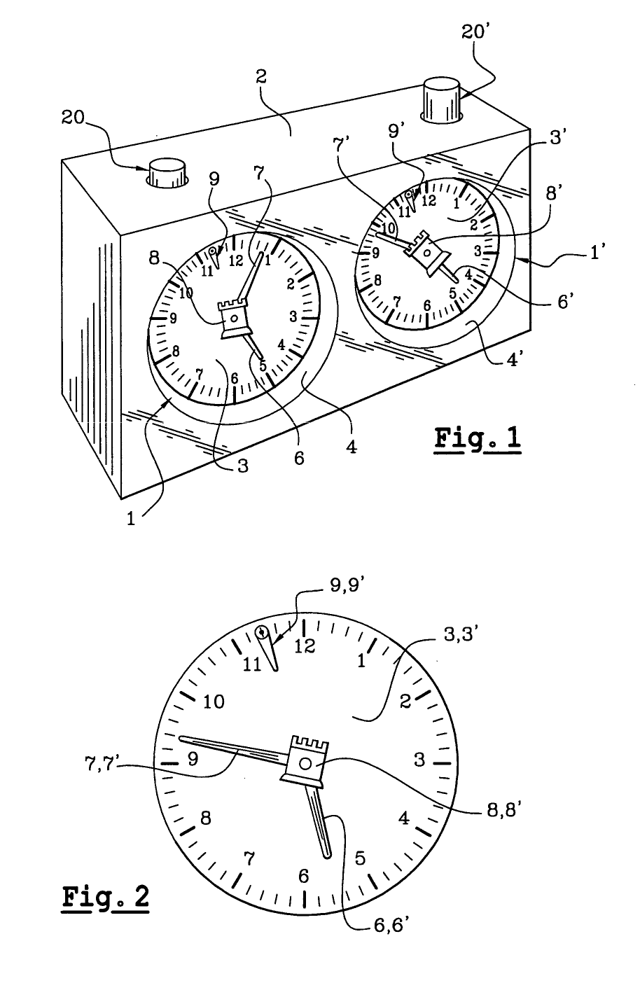

FIG. 1 is a perspective view of a clock for chess games according to this invention;

FIG. 2 is a enlarged front view of one of the dials of the clockworks;

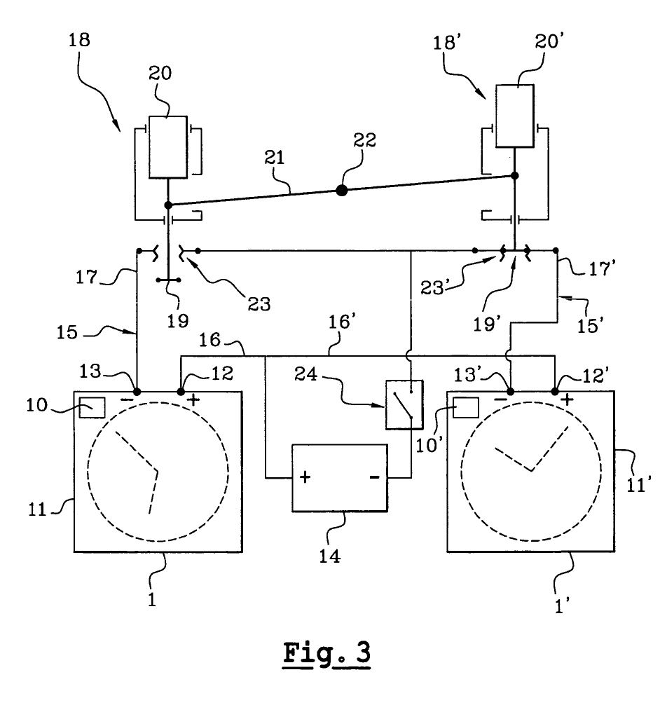

FIG. 3 is a diagrammatical view of a first possible embodiment of the control system of both clockworks;

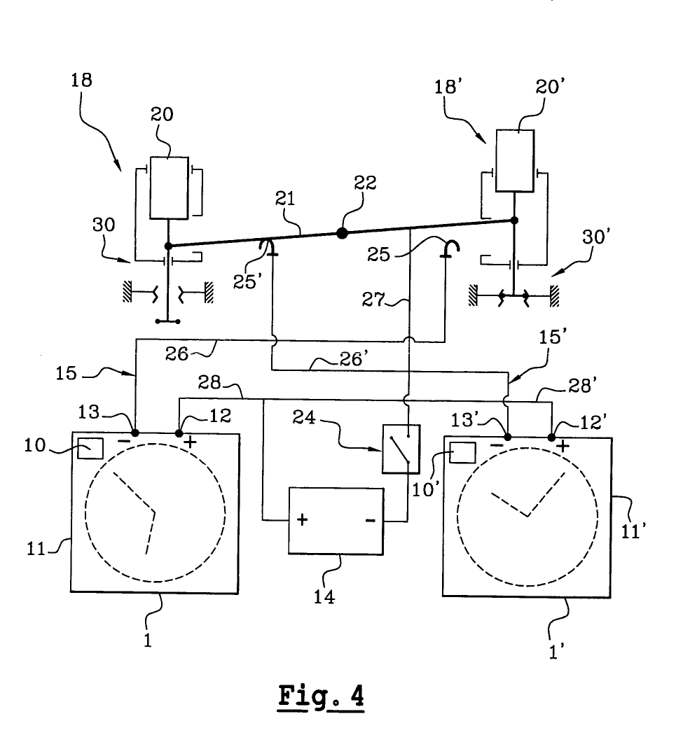

FIG. 4 is a diagrammatical view of a second possible embodiment of the control system of both clockworks.

The clock for chess games illustrated on FIG. 1 comprises two identical quartz clockworks 1 and 1′, housed in the same main box 2.

Both these clockworks 1 and 1′ are fitted with pointers moving in front of a circular dial 3, 3′; as can be seen below, these two clockworks are controlled each by their own quartz module, and their alternate operation is controlled by a system of switches interposed on their power supply circuits.

Both dials 3 and 3′ are arranged just behind circular transparent screens 4 and 4′ arranged on the front face of the box 2.

As can be seen in detailed on FIG. 2, each dial 3 and 3′ is divided conventionally into twelve sections opposite which moves a small pointer 6, 6′ marking the hours, and a larger pointer 7, 7′ marking the minutes. In the centre of the dials 3 and 3′ one notes the presence of a plate 8, 8′ which is mounted on the axis intended usually for the seconds' hand. These plates 8 and 8′ revolve around themselves at the rate of one revolution per minute, and they form an operation indicator enabling to visualise very quickly that of both clockworks during operation.

These decorative or informative plates 8 and 8′ may adopt any form or structure; in the embodiment illustrated on FIGS. 1 and 2, their shape is substantially that of a rook in a chess game.

Conventionally, the pointers 6, 6′ and 7, 7′ of each clockwork are associated with a manual operating device which enables to set or to adjust the time, at will. This operating device, which does not show on the Figures, consists of a manual rotary button, accessible for instance on the rear face of the box 2.

On the other hand, on each dial 3 and 3′, one may note the presence of a swinging indicator 9, 9′ positioned slightly upstream of the FIG. 12. These indicators 9, 9′ are intended for being actuated by the pointer of the minutes 7, 7′ in order to fall down exactly when said pointer 7, 7′ reaches the FIG. 12; their purpose is to indicate accurately the expiry of a time limit, in particular within the framework of a <<blitz >> game.

A first possible embodiment of the principle of operation and of control of both clockworks 1 and 1′ is illustrated diagrammatically on FIG. 3.

As can be seen on this FIG. 3, both clockworks 1 and 1′ comprise their own quartz control module 10, 10′, and they are integrated each in a box 11, 11′ fitted with a positive terminal 12, 12′ and with a negative terminal 13, 13′ to be power supplied by the same source of energy 14 (in the form of battery or batteries, rechargeable or not).

Both clockworks 1 and 1′ are mounted parallel on the positive and negative terminals of the source of energy 14 by means of an electric circuit, respectively 15 and 15′.

The electric circuits 15 and 15′ are composed of a system of electric wires 16, 16′ which connects the positive terminal of the source of energy 14 to the positive terminals 12, 12′ of the boxes 11, 11′, and of a system of electric wires 17, 17′ which connects the negative terminal of the source of energy 14 to the negative terminals 13, 13′ of said boxes 11 and 11′.

A system switch 18, 18′ is interposed on each of the electric circuits 15, 15′ to control the power supply of the clockworks 1, 1′; in the embodiment represented, these switches 18 and 18′ are placed on the systems of electric wires 17 and 17′.

The different electric wires 16, 16′, 17 and 17′ are preferably interconnected by welded spots on the terminals of the boxes 11, 11′ and of the source of energy 14, as well as on the inputs and outputs of the systems switches 18, 18′.

Both switches 18 and 18′ are each composed—of a contactor 19, 19′ to perform the opening and the closing of the associated circuit 15, 15′, and—of an operating member 20, 20′ in the form of a push-button; they are both mounted at each of the ends of an arm 21 which is hinged at 22, forming a pendulum.

Both switches 18, 18′ associated with the pendulum 21, 22 are structured so that depressing one of the push-buttons 20, 20′ deactivates the associated contactor 19, 19′ and, simultaneously, activates the other contactor 19′, 19.

Removable locking means 23, 23′, integrated to each switch 18, 18′ ensure correct and stable positioning of the contactors 19 and 19′ when they are in active closing position of the electric circuit 15, 15′.

As can be seen on FIG. 1, both push-buttons 20 and 20′ are arranged on the upper face of the box 2, respectively above each clockwork associated 1, 1′; these two push-buttons 20 and 20′ can consequently be operated by the players in order, after completing their move, to stop their own clockwork, and trigger that of the opponent.

The power supply batteries 14 are laid out in an appropriate housing provided in the main box 2; this housing is preferably associated with a removable trap to facilitate access to said batteries, with a view to the replacement thereof.

On the other hand, a main on/off switch 24 positioned on the main box 2 and interposed on a common part of the electric circuits 15, 15′ enables to break up the power supply of both clockworks 1, 1′, with a view notably to save the source of energy integrated.

FIG. 4 illustrates diagrammatically another possible embodiment of the principle of operation and of control of both clockworks 1 and 1′. On this figure, the sections identical or similar to the previous embodiment keep the same reference signs for easier understanding.

One sees again both clockworks 1, 1′, integrated in a box 11, 11′ and each comprising their own quartz control module 10, 10′; one also sees the electric circuits 15 and 15′ which connect the terminals 12, 13 and 12′, 13′ of the boxes 11 and 11′ to the terminals of the source of energy 14, whereon are interposed the systems switches 18 and 18′ actuated by the push-buttons 20 and 20′.

In this embodiment, the swinging arm 21 is made of a conductive metallic material and it is used, in combination with two contactors 25, 25′ in the form of flexible metallic blades, to open or close the electric circuits 15, 15′ according to its position controlled by the push-buttons 20, 20′.

The electric circuit 15 is composed—of an electric wire 26 which connects the negative terminal 13 of the box 11 and the contactor 25,—of an electric wire 27 which connects the swinging arm 21 and the negative terminal of the source of energy 14, passing through the main switch 24 and—of an electric wire 28 linking the positive terminal 12 of the box 11 and the positive terminal of the source of energy 14.

The electric circuit 15′ is composed—of an electric wire 26′ which connects the negative terminal 13′ of the box 11′ and the contactor 25′,—of the electric wire 27 which connects the swinging arm 21 and the negative terminal of the source of energy 14, and—of an electric wire 28′ linking the positive terminal 12′ of the box 11′ and the positive terminal of the source of energy 14.

The different electric wires 26, 26′, 27, 28, 28′ are preferably interconnected by welded spots on the terminals of the boxes 11, 11′ and of the source of energy 14, as well as on the contactors 25, 25′ and the swinging arm 21, forming then the inputs and outputs of the systems switches 18 and 18′.

Both switches 18 and 18′ comprise besides the means 30 and 30′ which enable to lock, in a removable fashion, their inactive closing position of the circuits 15 and 15′. These means can adopt any appropriate mechanical shapes.

Preferably, the quartz clockworks 1, 1′ which are used to produce the chess clock according to this invention, are clockworks commercially available and corresponding to simple quartz <<alarm clocks>> supplied by a battery. Within the framework of this invention, the battery of each mechanism has been removed and the electric wires of the circuits 15 and 15′ are welded on the contact terminals of said batteries.

1.- A clock for chess games, composed of two pointer clockworks whereof the operation is controlled by a quartz system powered by a source of energy, which clockworks are associated each with a control device in the form of a switch, which switches are connected together so that deactivating a first switch causes, on the one hand, the clockwork associated with this first switch to stop, and on the other hand activates the second switch and triggers the clockwork associated with this second switch, characterised in that it comprises a first clockwork (1) controlled by its own quartz module (10), and a second clockwork (1′) also controlled by its own quartz module (10′), which clockworks (1, 1′) comprise each a power supply electric circuit (15, 15′), the control means in the form of switches (18, 18′) of said clockworks (1, 1′) being placed each on one of said electric circuits (15, 15′).

2.- A clock for chess games according to the claim 1, characterised in that it comprises two quartz-type clockworks (1, 1′) supplied by the same source of energy (14) on the terminals whereof they are mounted in parallel.

3.- A clock for chess games according to the claim 2, characterised in that it comprises quartz clockworks (1, 1′) integrated each in their own box (11, 11′) fitted with a positive terminal (12, 12′) and with a negative terminal (13, 13′) for their power supply by the source of energy (14), a system of electric wires (16, 16′, 17, 17′; 26, 26′, 27, 28, 28′) linking, on the one hand, the positive terminal of the source of energy (14) to the positive terminals (12, 12′), of said boxes (11, 11′), and on the other hand, the negative terminal of said source of energy (14) to the negative terminals (13, 1.3′) of said boxes (11, 11′), to form the electric circuits (15, 15′) for power supply.

4.- A clock for chess games according to the claim 3, characterised in that it comprises two switching devices (18, 18′) comprising each—a contact system (19, 19′; 21, 25, 25′) to open or close the corresponding electric circuit (15, 15′), and—an operating member (20, 20′) of said contact system (19, 19′; 21, 25, 25′), said operating members (20, 20′) of each switch (18, 18′) being arranged at each of the ends of a swinging arm (21, 22) forming a pendulum.

5.- A clock for chess games according to the claim 4, characterised in that it comprises two system switches (18, 18′) fitted of means (23, 23′) to lock, in a removable fashion, their active closing position of the corresponding electric circuit (15, 15′).

6.- A clock for chess games according to the claim 4, characterised in that it comprises two systems switches (18, 18′) fitted with means (30, 30′) to lock, in a removable fashion, their inactive closing position of the corresponding electric circuit (15, 15′).

7.- A clock for chess games according to any of the claims 4 to 6, characterised in that it comprises a swinging arm (21) made of conductive material, which arm (21), connected to the source of energy (14), touches, according to its position, one of the contactors (25, 25′) of both switches (18, 18′) to close the corresponding electric circuit (15, 15′).

8.- A clock for chess games according to any of the claims 3 to 7, characterised in that both boxes (11, 11′) forming both quartz clockworks (1, 1′), are integrated in a main box (2) which is fitted with a housing for the reception of one or several batteries (14) supplying said clockworks (1, 1′), which box (2) comprises two transparent screens (4, 4′) arranged opposite both dials (3, 3′) of said clockworks (1, 1′), as well as two switches (18, 18′) fitted each with an operating member in the form of a pushbutton (20, 20′), which push-buttons (20, 20′) are placed each above of the associated clockwork (1, 1′) and emerge in the upper face of the main box (2).

9.- A clock for chess games according to any of the claims 1 to 8, characterised in that it comprises a main on/off switch (24) enabling to break up the power supply of both clockworks (1, 1′).

10.- A clock for chess games according to any of the claims 1 to 9, characterised in that each clockwork (1, 1′) comprises a dial (3, 3′) associated with an operation indicator (8, 8′) in the form of a decorative or informative plate mounted on the axis of the seconds' hand, in replacement thereof.
